(19) United States
(12) Patent Application Publication
(10) Pub. No.: US 2015/0364043 A1
(43) Pub. Date: Dec. 17, 2015

(54) PARKING SYSTEM OF VEHICLE

(71) Applicant: Hyundai Mobis Co., Ltd., Seoul (KR)

(72) Inventor: Seong soo LEE, Yongin-si (KR)

(21) Appl. No.: 14/724,322

(22) Filed: May 28, 2015

(30) Foreign Application Priority Data
Jun. 11, 2014 (KR) 10-2014-0071036

(51) Int. Cl. G08G 1/14; G06K 9/00

(52) U.S. Cl. CPC G08G 1/143; G06K 9/00812

(57) ABSTRACT

A parking system of a vehicle, including: a display unit; an image obtaining unit configured to obtain a rear image of a vehicle; an encoder unit configured to measure an encoder value for a rotation of a wheel installed in the vehicle; and a controller configured to determine a target parking section based on a parking line and a parking crossing point recognized in the rear image, and control a combined image obtained by combining the target parking section and a current position of the vehicle estimated according to the target parking section and the encoder value to be displayed on the display unit.

### CROSS-REFERENCE TO RELATED APPLICATION

This application claims priority from and the benefit of Korean Patent Application No. 10-2014-0071036, filed Jun. 11, 2014, which is hereby incorporated by reference for all purposes as if fully set forth herein.

### BACKGROUND

1. Field

The present invention relates to a parking system of a vehicle which provides a combined image obtained by combining a target parking section, in which a vehicle will be parked, and a current position of the vehicle in an image with respect to the rear facing direction of the vehicle to enable a driver to easily park.

2. Discussion of the Background

Vehicular travel has been a part of society for over a century. As vehicles have gained acceptance as a main and representative transportation means in modern city life, the supply of vehicles has been rapidly increasing and thus, the number drivers has greatly increased in proportion to the increase in the supply of vehicles.

In the meantime, an automatic parking system has been developed in order to provide parking assistance, and various types of products directed to the automatic parking system have been sold.

A typical automatic parking system first determines whether parking is available by scanning a space for parking by using an ultrasonic sensor mounted in a vehicle, and checking for the presence of an obstacle located in a corresponding region. However, this system has a disadvantage in that a direction of a target parking position may be misaligned according to a posture of a previously parked vehicle, and a boundary of vehicles parked at left and right sides cannot be precisely recognized according to a characteristic of the ultrasonic sensor having a predetermined beam width, so that a success rate of setting a target parking position is low.

Recently, an automatic vehicle monitoring (AVM) system including front, rear, left, and right cameras mounted has been developed, so that it is possible to easily recognize a parking section and a position of a current vehicle from an combined surround image, but research for providing a similar combined image to the combined surround image without to applying the AVM system has recently been conducted.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a parking system of a vehicle, which provides a combined image obtained by combining a target parking section, in which a vehicle will park, and a current position of the vehicle in an image with respect to the rear facing direction of the vehicle to enable a driver to easily park.

Additional aspects will be set forth in the detailed description which follows, and, in part, will be apparent from the disclosure, or may be learned by practice of the inventive concept.

An exemplary embodiment of the present invention discloses a parking system of a vehicle, including: a display unit; an image obtaining unit configured to obtain a rear image of a vehicle; an encoder unit configured to measure an encoder value for a rotation of a wheel installed in the vehicle; and a controller configured to determine a target parking section based on a parking line and a parking crossing point recognized in the rear image, and to control a combined image obtained by combining the target parking section and a current position of the vehicle estimated according to the target parking section and the encoder value to be displayed on the display unit.

An exemplary embodiment of the present invention also discloses a method of operating a parking system of a vehicle, including: obtaining a rear image of a vehicle through a camera; measuring an encoder value for a rotation of a wheel installed in the vehicle through an encoder unit; determining a target parking section based on a parking line and a parking crossing point recognized in the rear image; generating a combined image obtaining by combining the target parking section and a current position of the vehicle estimated according to the target is parking section and the encoder value; and displaying the target parking section and the combined image on a display unit.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a control block diagram illustrating a control configuration of a parking system of a vehicle according to an exemplary embodiment of the present invention.

FIGS. 2A and 2B are diagrams illustrating an example of a combined image for the parking system of the vehicle according to an exemplary embodiment of the present invention.

FIG. 3 is a diagram illustrating an example of a display of a display unit for the parking system of the vehicle according to an exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced is without these specific details or with one or more equivalent arrangements. In other instances, well-known structures and devices are shown in block diagram form in order to avoid unnecessarily obscuring various exemplary embodiments.

In the accompanying figures, the size and relative sizes of various elements, etc., may be exaggerated for clarity and descriptive purposes. Also, like reference numerals denote like elements.

When an element is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element, there are no intervening elements present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, and/or sections, these elements, components, regions, and/or sections should not be limited by these terms. These terms are used to distinguish one element, component, region, and/or section from another element, component, region, layer, and/or section. Thus, a first element, component, region, and/or section discussed below could be termed a second element, component, region, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

An angle and a direction mentioned in the describing of a structure of any of the exemplary embodiments of the present invention are based on illustrations contained in the drawings. Unless a reference point for an angle and a position relation are clearly mentioned in the description of a structure of a light emission device in the specification, relevant drawings will be referred to.

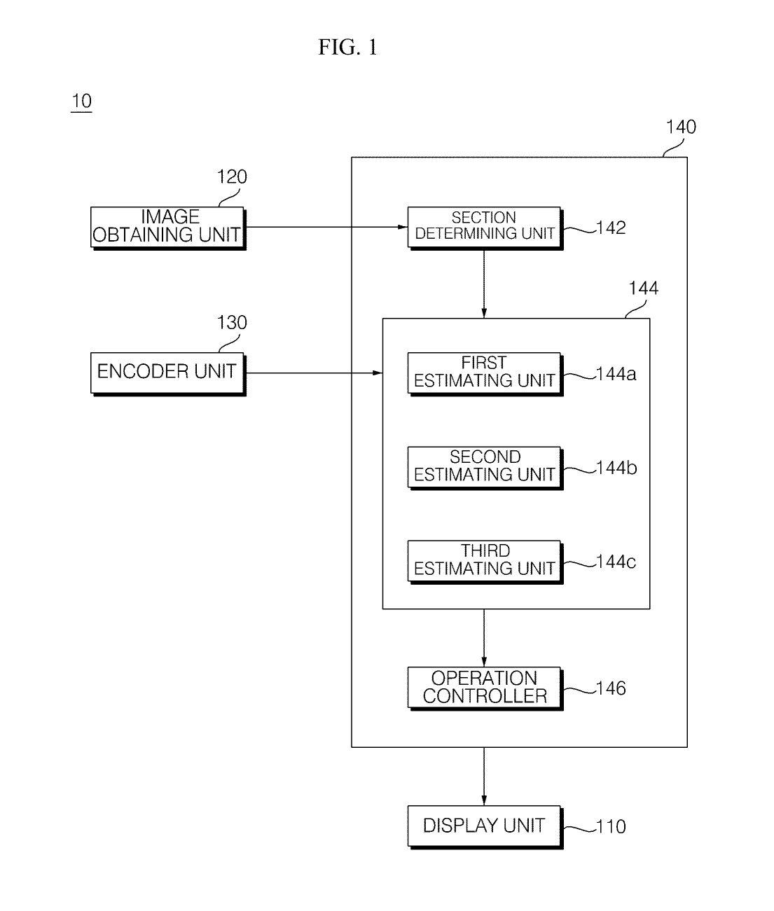

FIG. 1 is a control block diagram illustrating a control configuration of a parking system of a vehicle according to an exemplary of the present invention.

Referring to FIG. 1, a parking system of a vehicle 10 may include a display unit 110, an image obtaining unit 120, an encoder unit 130, and a controller 140.

The display unit 110 may display a rear image 20 with respect to the rear facing direction of the vehicle 10 obtained by the image obtaining unit 120, and a combined image 30 combined by the controller 140.

Here, the display unit 110 may divide and display the rear image 20 and the combined image 30.

The image obtaining unit 120 may include one or more cameras (not shown) mounted at a rear side of the vehicle to photograph the rear image 20.

That is, the image obtaining unit 120 may photograph the image under control of the controller 140, or automatically photograph the rear image 20 when a vehicle gear state is changed to a reverse gear state, but the present invention is not limited thereto.

The image obtaining unit 120 may transmit the photographed rear image 20 to the controller 140 in real time.

The encoder unit 130 may measure an encoder value for a rotation of a wheel mounted in the vehicle.

That is, the encoder unit 130 may be mounted to a steering wheel connected to the wheel, but is not limited thereto.

The controller 140 may include a section determining unit 142, a position estimating unit 144, and an operation controller 146.

The section determining unit 142 recognizes a parking line 35 and a parking crossing point 37 in the rear image 20, and determines a target parking section in which the vehicle 10 is to be parked.

That is, the section determining unit 142 may recognize the parking line 35 and the parking crossing point 37 in the rear image 20 by applying a set line fitting algorithm and Harris corner algorithm, but is not limited thereto.

The section determining unit 142 may determine the target parking section larger than a size of the vehicle 10 by applying the parking line 35 and the parking crossing point 37 to a section algorithm.

That is, the section determining unit 142 may set an initial size of the target parking section to be larger than the size of the vehicle 10, and correct the initial size according to the current position of the vehicle 10 estimated by the position estimating unit 144, but is not limited thereto.

The position estimating unit 144 may estimate the current position based on the target parking section and the encoder value.

That is, the position estimating unit 144 may include a first estimating unit 144a for estimating a first current position of the vehicle 10 based on the encoder value, a second estimating unit 144b for calculating a rotation component and a movement component so that section corner coordinates for the target parking section are matched with corner coordinates is stored in a predetermined parking section to estimate a second current position of the vehicle, and a third estimating unit 144c for estimating or correcting the current position by applying the first and second current position to the set Kalman filter.

Here, the second estimating unit 144b calculates the section corner coordinates for a front section corner for the target parking section before the vehicle 10 enters the target parking section, and calculates the section corner coordinates for a rear section corner for the target parking section after the vehicle enters the target parking section.

The operation controller 146 may generate the combined image 30 obtained by combining the target parking section and the current position, and control the display unit 110 so that the generated combined image 30 is displayed on the display unit 110.

The operation controller 146 may form a first line 40 on a center axis of the target parking section and a second line 50 corresponding to the first line 40 at the current position, and control the display unit 110 so that an inclination angle θ between the first and second lines 40, 50 is displayed, but is not limited thereto.

The parking system of the vehicle according to the present invention may display the rear image 20 obtained by the image obtaining unit 120 and the combined image 30 obtained by combining the target parking section determined in the rear image 20 and the current position of the vehicle on the display unit 110, thereby enabling a driver to easily park the vehicle at the target parking section.

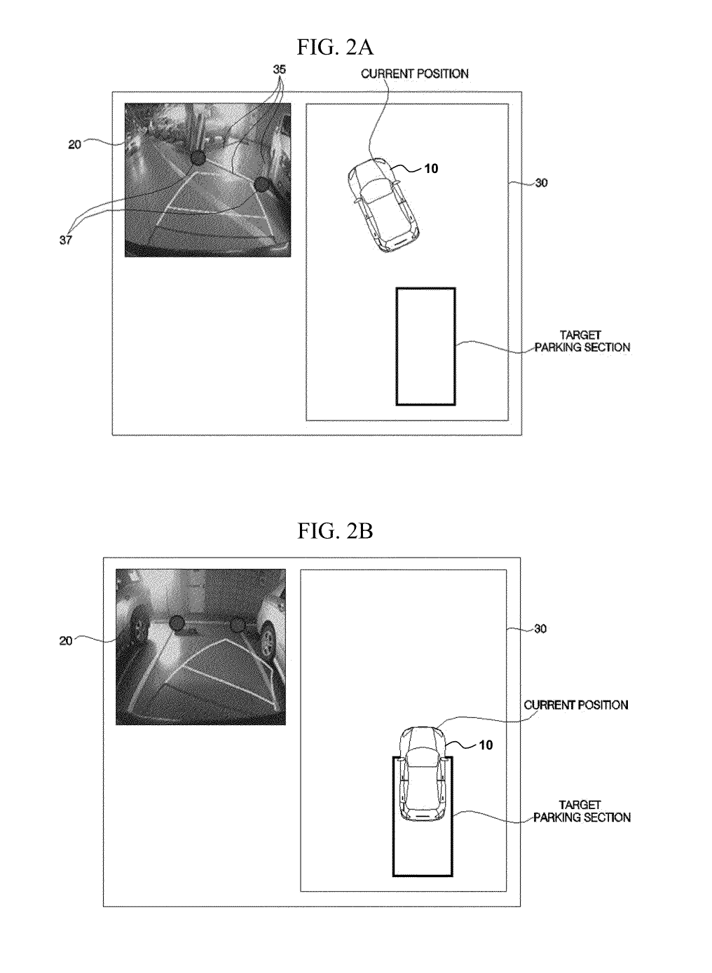

FIGS. 2A and 2B are diagrams illustrating an example of a combined image 30 for the parking system of the vehicle 10 according to an exemplary embodiment of the present invention.

FIG. 2A illustrates a target parking section and a current position of a vehicle before the vehicle enters the target parking section.

Referring to FIG. 2A, the controller 140 may recognize a parking line 35 and a parking crossing point 37 in the rear image 20.

Here, the controller 140 may recognize the parking line 35 and the parking crossing point 37 by applying the line fitting algorithm and the Harris corner algorithm and determine the target parking section by adopting the set section algorithm, as described above.

Then, the controller 140 may estimate the current position of the vehicle 10 based on an encoder value for a rotation of a wheel, and generate a combined image 30 formed of a predetermined shape of the vehicle 10 located at the current position and the target parking section, and control the generated combined image 30 to be displayed on the display unit 110.

FIG. 2B illustrates the combined image displayed after the vehicle 10 reverses for parking and enters the target parking section after the position of the vehicle 10 shown FIG. 2A.

That is, referring to FIG. 2B, the controller 140 displays the rear image 20 and the combined image 30 after the vehicle 10 enters the target parking section, and determines the target parking section by the aforementioned method, but is not limited thereto.

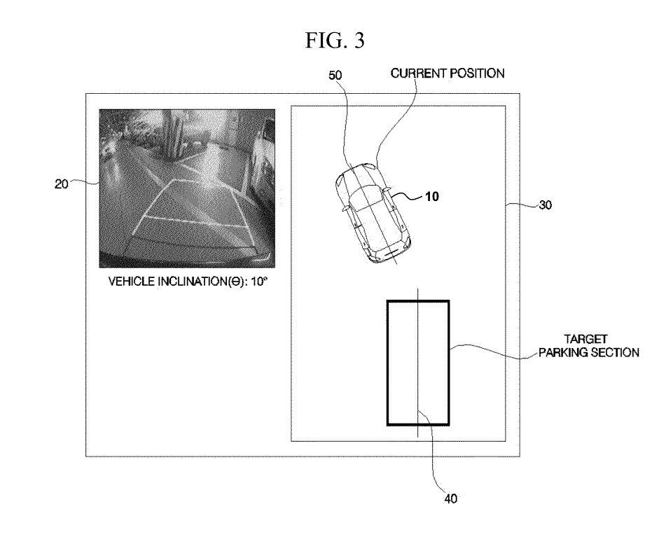

FIG. 3 is a diagram illustrating an example of a display of the display unit 110 for the parking system of the vehicle 10 according to an exemplary embodiment of the present invention.

Referring to FIG. 3, the combined image 30 obtained by combining the current position of the vehicle 10 and the target parking section by the controller 140 and the rear image 20 obtained by the image obtaining unit 120 may be displayed on the display unit 110.

Here, in the combined image 30, the first line 40 may be formed on the center axis of the target parking section, and the second line 50 corresponding to or overlapping the first line 40 may be formed when the vehicle 10 is parked at the current position of the vehicle.

The display unit 110 may represent an inclination angle θ between the first and second lines 40, 50, that is, an inclination of the vehicle 10, by a numerical value, but is not limited thereto.

The parking system of the vehicle according to the present invention does not require a high-priced AVM system, and may determine a target parking section by obtaining an image with respect to the rear facing direction of the vehicle and recognizing a parking line and a parking crossing point, and may display a combined image obtained by combining the target parking section and a current position of the vehicle estimated based on the target parking section and an encoder value on the display unit, thereby enabling a driver to recognize the current position and the target parking section of the vehicle and thus enabling the driver to easily park.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A parking system of a vehicle, comprising:
a display unit;
an image obtaining unit configured to obtain a rear image with respect to a rear facing direction of a vehicle;
an encoder unit configured to measure an encoder value for a rotation of a wheel installed in the vehicle; and
a controller configured to determine a target parking section based on a parking line and a parking crossing point recognized in the rear image, and control a combined image obtained by combining the target parking section and a current position of the vehicle estimated according to the target parking section and the encoder value to be displayed on the display unit.

2. The parking system of claim 1, wherein the display unit is configured to divide and display the rear image and the combined image.

3. The parking system of claim 1, wherein the image obtaining unit comprises at least one camera.

4. The parking system of claim 1, wherein the controller comprises:
a section determining unit configured to recognize the parking line and the parking crossing point in the rear image and determine the target parking section at which the vehicle is parked;
a position estimating unit configured to estimate the current position based on the target parking section and the encoder value; and
an operation controller configured to generate the combined image obtained by combining the target parking section and the current position, and control the generated combined image to be displayed on the display unit.

5. The parking system of claim 4, wherein the section determining unit is configured to recognize the target parking section by applying a line fitting algorithm or a Harris corner algorithm based on the parking line and the parking crossing point in the rear image.

6. The parking system of claim 4, wherein the section determining unit is configured to determine the target parking section larger than a size of the vehicle by applying a section algorithm based on the parking line and the parking crossing point.

7. The parking system of claim 4, wherein the position estimating unit comprises:
a first estimating unit configured to estimate a first current position of the vehicle based on the encoder value;
a second estimating unit configured to calculate a rotation component and a movement component so that section corner coordinates of the target parking section are matched with corner coordinates stored in a predetermined parking section, and estimate a second current position of the vehicle; and
a third estimating unit configured to estimate or correct the current position by applying the first and second current positions to a set Kalman filter.

8. The parking system of claim 7, wherein the second estimating unit is configured to calculate the section corner coordinates for a front section corner for the target parking section before the vehicle enters the target parking section, and calculate the section corner coordinates for a rear section corner for the target parking section after the vehicle enters the target parking section.

9. The parking system of claim 8, wherein the operation controller is configured to form a first line on a center axis of the target parking section and a second line corresponding to the first line at the current position, and control an inclination angle between the first and second lines to be displayed on the display unit.

10. A method of operating a parking system of a vehicle, comprising:
obtaining a rear image with respect to a rear facing direction of a vehicle through a camera;
measuring an encoder value for a rotation of a wheel installed in the vehicle through an encoder unit;
determining a target parking section based on a parking line and a parking crossing point recognized in the rear image;
generating a combined image obtaining by combining the target parking section and a current position of the vehicle estimated according to the target parking section and the encoder value; and
displaying the target parking section and the combined image on a display unit.

11. The method of claim 10, wherein the displaying comprises dividing and displaying the rear image and the combined image.

12. The method of claim 10, wherein the determining comprises determining the target parking section by applying a line fitting algorithm or a Harris corner algorithm based on the parking line and the parking crossing point in the rear image.

13. The parking system of claim 10, wherein the determining comprises determining the target parking section larger than a size of the vehicle by applying a section algorithm based on the parking line and the parking crossing point.
